(19) United States
(12) Patent Application Publication
(10) Pub. No.: US 2026/0110899 A1
(43) Pub. Date: Apr. 23, 2026

(54) METHOD FOR OPTIMAL MULTI-CAMERA CONTROL SYSTEM

(71) Applicant: Samsung Electronics Co., Ltd., Suwon-si (KR)

(72) Inventors: GREEN ROSH K S, Bangalore (IN); Bindigan Hariprasanna PAWAN PRASAD, Bangalore (IN); Vishakha S R, Bangalore (IN); Meghana SHANKAR, Bangalore (IN); Akula JAYAPRAKASH, Bangalore (IN); Prateek KUKREJA, Bangalore (IN); Sagar PARMAR, Bangalore (IN); Sungsoo CHOI, Suwon-si (KR); Hyuntaek WOO, Suwon-si (KR)

(21) Appl. No.: 19/360,568

(22) Filed: Oct. 16, 2025

Related U.S. Application Data
(63) Continuation of application No. PCT/KR2025/016372, filed on Oct. 16, 2025.

(30) Foreign Application Priority Data
Oct. 21, 2024 (IN) 202441079884

(51) Int. Cl. G02B 27/00; G02B 27/01; G06F 3/01

(52) U.S. Cl. CPC G02B 27/0093; G02B 27/0172; G06F 3/017; G02B 2027/0138; G02B 2027/014

(57) ABSTRACT

A method for optimizing a camera for hand tracking in a Head Mounted Device (HMD) is provided. The method includes detecting, by the HMD, an initiation of a hand gesture, wherein the HMD comprises a plurality of cameras configured to generate a plurality of image frames, determining, by the HMD, a context of initiation of the hand gesture as identified within the plurality of generated image frames, predicting, based on the determined context of initiation, by the HMD, a type of hand gesture and a trajectory of hand motion required to perform the hand gesture, estimating, by the HMD, a hand speed at a plurality of points along the predicted trajectory, identifying, by the HMD, at least one camera among the plurality of cameras of the HMD whose Field Of View (FOV) intersects with the estimated hand speed at the plurality of points along the predicted trajectory, and configuring, by the HMD, one or more operation parameters of the at least one camera in proportion to the estimated hand speed.

### CROSS REFERENCE TO RELATED APPLICATION(S)

This application is a continuation application, claiming priority under 35 U.S.C. § 365 (c), of an International application No. PCT/KR2025/016372, filed on Oct. 16, 2025, which is based on and claims the benefit of an Indian Complete patent application No. 202441079884, filed on Oct. 21, 2024, in the Indian Patent Office, the disclosure of which is incorporated by reference herein in its entirety.

### FIELD OF THE INVENTION

The disclosure relates to the field of image processing. More particularly, the disclosure relates to a method for an optimal multi-camera control system.

### BACKGROUND

Image processing refers to a process associated with manipulation and analysis of digital images through algorithms and computational techniques to enhance, transform, or extract meaningful information from the digital images. The image processing encompasses various operations such as filtering, segmentation, and feature extraction, aimed at improving image quality or facilitating automated analysis. In the context of Head Mounted Devices (HMDs), the image processing plays a crucial role in rendering immersive visual experiences. The HMDs utilize advanced image processing techniques to manage real-time rendering, depth perception, and spatial awareness. This advanced image processing involves adjusting image parameters based on user interactions and environmental factors, ensuring that virtual objects align accurately with a user's line of sight. Furthermore, one or more image processing algorithms are employed in the HMDs for motion tracking and fusing data from multiple sensors, enhancing the realism and responsiveness of Augmented Reality (AR) and Virtual Reality (VR) applications, to achieve seamless and engaging user experiences in HMD environments.

The above information is presented as background information only to assist with an understanding of the disclosure. No determination has been made, and no assertion is made, as to whether any of the above might be applicable as prior art with regard to the disclosure.

### SUMMARY

However, several problems are encountered in the existing HMDs, which are mentioned below.

FIGS. 1A, 1B, and 1C illustrate one or more functionalities and problems associated with the existing HMD, according to the related art.

A typical HMD is equipped with multiple cameras and sensors to facilitate human-environment interaction. For example, the HMD 10 currently employs 6-10 cameras for hand and head tracking, along with additional Time-of-Flight (ToF) sensors for depth perception, and extra cameras for eye and facial tracking, as illustrated in FIG. 1A. To ensure precise tracking of head and hand movements, all cameras operate continuously at high frame rates/Frame Per Second (FPS) and resolutions. Certain applications, such as micro-gesture detection, necessitate high-resolution streaming at 60 FPS. However, operating all cameras simultaneously with high-resolution streaming significantly increases power consumption, leading to reduced battery life and thermal issues, which can result in adverse user experiences, including frequent battery depletion, overheating, avatar freezing, etc.

For instance, consider a scenario where a VR training application is designed for medical professionals using the HMD 10. In this scenario, the HMD 10 is equipped with multiple cameras and sensors to accurately track the user's head, hands, and facial expressions during surgical simulations. As the user interacts with a virtual patient, the HMD 10 employs 8 cameras to monitor hand movements for precise manipulation of virtual surgical instruments, while additional sensors provide depth information to gauge the distance between the user and the virtual environment. To enhance realism, the HMD 10 requires high-resolution video streaming at 60 FPS to capture subtle micro-gestures, such as the delicate movements needed for suturing. However, maintaining this level of performance leads to significant power consumption, causing the device to overheat, and resulting in a shortened battery life. The user may experience avatar freezing or frequent interruptions due to thermal throttling, ultimately hindering the training experience.

In addition, the existing HMDs 10 exhibit a lack of logical processing regarding camera operation. Specifically, there is no mechanism to recognize that high frame rates are unnecessary when the user's hand 30 is not within the camera's field of view. For instance, the existing HMDs operate six integrated cameras continuously in a high-power mode throughout the observation period (e.g., from T=t₁ to T=t₄), as illustrated in FIG. 1B. Likewise, high resolution becomes redundant when the hand 30 is not performing any gestures. This oversight results in inefficient use of resources, as the existing HMDs 10 fail to adapt to the actual requirements of the user's interactions. Moreover, existing HMDs 10 have also explored the use of external batteries 20 to mitigate battery life concerns, as illustrated in FIG. 1C. However, this external batteries approach compromises portability and usability.

Aspects of the disclosure are to address at least the above-mentioned problems and/or disadvantages and to provide at least the advantages described below. Accordingly, an aspect of the disclosure is to provide a useful alternative for an optimal multi-camera control system.

Additional aspects will be set forth in part in the description which follows and, in part, will be apparent from the description, or may be learned by practice of the presented embodiments.

In accordance with an aspect of the disclosure, a method for optimizing a camera for hand tracking in a Head Mounted Device (HMD) is provided. The method includes detecting, by the HMD, an initiation of a hand gesture, wherein the HMD comprises a plurality of cameras configured to generate a plurality of image frames, determining, by the HMD, a context of initiation of the hand gesture as identified within the plurality of generated image frames, predicting, based on the determined context of initiation, by the HMD, a type of hand gesture and a trajectory of hand motion required to perform the hand gesture, estimating, by the HMD, a hand speed at a plurality of points along the predicted trajectory, identifying, by the HMD, at least one camera among the plurality of cameras of the HMD whose Field Of View (FOV) intersects with the estimated hand speed at the plurality of points along the predicted trajectory, and configuring, by the HMD, one or more operation parameters of the at least one camera in proportion to the estimated hand speed.

In accordance with another aspect of the disclosure, an HMD for optimizing a camera for hand tracking is provided. The HMD includes memory storing one or more computer programs, and one or more processors communicatively coupled to the memory, a communicator, a camera module, and a display module, wherein the one or more computer programs include computer-executable instructions that, when executed by the one or more processors individually or collectively, cause the HMD to detect an initiation of a hand gesture, wherein the HMD comprises a plurality of cameras configured to generate a plurality of image frames, determine a context of initiation of the hand gesture as identified within the plurality of generated image frames, predict, based on the determined context of initiation, a type of hand gesture, and a trajectory of hand motion required to perform the hand gesture, estimate a hand speed at a plurality of points along the predicted trajectory, identify at least one camera among the plurality of cameras of the HMD whose Field Of View (FOV) intersects with the estimated hand speed at the plurality of points along the predicted trajectory and configure one or more operation parameters of the at least one camera in proportion to the estimated hand speed.

In accordance with another aspect of the disclosure, one or more non-transitory computer-readable storage media storing one or more computer programs including computer-executable instructions that, when executed by one or more processors of a Head Mounted Device (HMD) individually or collectively, cause the HMD to perform operations, the operations are provided. The operations include detecting, by the HMD, an initiation of a hand gesture, wherein the HMD comprises a plurality of cameras configured to generate a plurality of image frames, determining, by the HMD, a context of initiation of the hand gesture as identified within the plurality of generated image frames, predicting, based on the determined context of initiation, by the HMD, a type of hand gesture and a trajectory of hand motion required to perform the hand gesture, estimating, by the HMD, a hand speed at a plurality of points along the predicted trajectory, identifying, by the HMD, at least one camera among the plurality of cameras of the HMD whose Field Of View (FOV) intersects with the estimated hand speed at the plurality of points along the predicted trajectory, and configuring, by the HMD, one or more operation parameters of the at least one camera in proportion to the estimated hand speed.

In accordance with another aspect of the disclosure, a method for controlling a Head Mounted Device (HMD) is provided. The method includes detecting, by the HMD, a gesture of a user, wherein the HMD comprises a plurality of cameras configured to obtain a plurality of image frames, determining, by the HMD, a context of the gesture of the user as identified using the plurality of obtained image frames, based on the context related to the gesture, predicting, by the HMD, a trajectory of the gesture, estimating, by the HMD, a speed of a body part of the user corresponding to the gesture at a plurality of points included in the predicted trajectory, identifying, by the HMD, at least one camera, among the plurality of cameras of the HMD, corresponding to the plurality of points based on FOV of the plurality of cameras, and based on the estimated speed of the body part of the user, configuring, by the HMD, one or more operation parameters of the at least one camera corresponding to the plurality of points.

In accordance with another aspect of the disclosure, an HMD is provided. The HMD includes memory storing one or more computer programs, and one or more processors, communicatively coupled to the memory, a communicator, a camera module and a display module, wherein the one or more computer programs include computer-executable instructions that, when executed by the one or more processors individually or collectively, cause the HMD to, detect a gesture of a user, wherein the HMD comprises a plurality of cameras configured to obtain a plurality of image frames, determine a context of the gesture as identified using the plurality of obtained image frames, based on the context related to the gesture, predict, a trajectory of hand motion required to perform the gesture, estimate a speed of a body part of the user corresponding to the gesture at a plurality of points included in the predicted trajectory, identify at least one camera, among the plurality of cameras of the HMD, corresponding to the plurality of points based on FOV of the plurality of cameras, and based on the estimated speed of the body part of the user, configure one or more operation parameters of the at least one camera corresponding to the plurality of points.

In accordance with another aspect of the disclosure, one or more non-transitory computer-readable storage media storing one or more computer programs including computer-executable instructions that, when executed by one or more processors of a Head Mounted Device (HMD) individually or collectively, cause the HMD to perform operations, the operations are provided. The operations include detecting, by the HMD, a gesture of a user, wherein the HMD comprises a plurality of cameras configured to obtain a plurality of image frames, determining, by the HMD, a context of the gesture of the user as identified using the plurality of obtained image frames, based on the context related to the gesture, predicting, by the HMD, a trajectory of the gesture, estimating, by the HMD, a speed of a body part of the user corresponding to the gesture at a plurality of points included in the predicted trajectory, identifying, by the HMD, at least one camera, among the plurality of cameras of the HMD, corresponding to the plurality of points based on FOV of the plurality of cameras, and based on the estimated speed of the body part of the user, configuring, by the HMD, one or more operation parameters of the at least one camera corresponding to the plurality of points.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, and 1C illustrate one or more functionalities and problems associated with the existing HMD, according to the related art;

FIG. 2 illustrates a block diagram of a Head Mounted Device (HMD) for dynamically configuring one or more operation parameters of at least one camera associated with the HMD, according to an embodiment of the disclosure;

FIG. 3 is a flow diagram illustrating a method for dynamically configuring the one or more operation parameters of the at least one camera associated with the HMD, according to an embodiment of the disclosure;

FIGS. 4A and 4B illustrate example scenarios where the HMD performs to determine future hand trajectory data corresponding to one or more FOVs of the HMD, according to various embodiments of the disclosure;

FIGS. 5A, 5B, and 5C illustrate example scenarios where the HMD performs one or more operations to dynamically configure the at least one camera, according to various embodiments of the disclosure;

FIG. 6 illustrates an example scenario where the HMD performs one or more operations to dynamically configure the at least one camera to operate at various Frame Per Second (FPS) and/or a various resolution mode, according to an embodiment of the disclosure; and

FIG. 7 is a flow diagram illustrating a method for dynamically configuring the one or more operation parameters of the at least one camera associated with the HMD, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “camera” and “camera module” are used interchangeably and mean the same.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

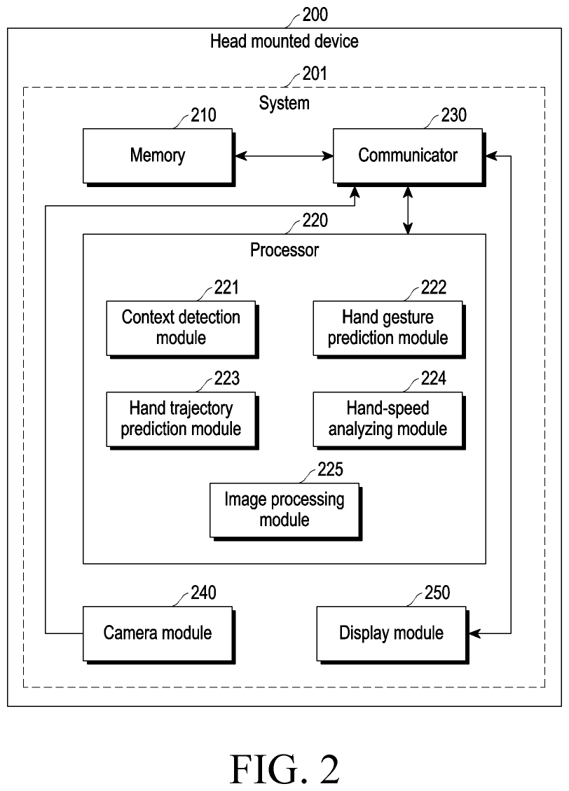

Referring now to the drawings, and more particularly to FIGS. 2, 3, 4A, 4B, 5A to 5C, 6, and 7, where similar reference characters denote corresponding features consistently throughout the figures, there are shown preferred embodiments.

FIG. 2 illustrates a block diagram of a Head Mounted Device (HMD) 200 for dynamically configuring one or more operation parameters of at least one camera associated with the HMD 200, according to an embodiment of the disclosure. Examples of the HMD 200 may include, but are not limited to, a visual see through device, an Augmented Reality (AR) device, and a Virtual Reality (VR) device, etc.

In one or more embodiments, the HMD 200 comprises a system 201. The system 201 may include memory 210, a processor 220, a communicator 230, a camera module 240, and a display module 250. In one embodiment, the system 201 may be implemented and/or associated with one or multiple electronic devices (not shown in FIG. 2).

In one or more embodiments, the memory 210 stores instructions to be executed by the processor 220 for optimizing the camera (e.g., camera module 240) for the hand tracking in the HMD 200, as discussed throughout the disclosure. The memory 210 may include non-volatile storage elements. Examples of such non-volatile storage elements may include magnetic hard discs, optical discs, floppy discs, flash memories, or forms of electrically programmable read only memory (EPROM) or electrically erasable and programmable read only memory (EEPROM). In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit, or it can be an external storage unit of the HMD 200, a cloud storage, or any other type of external storage.

In one or more embodiments, the processor 220 communicates with the memory 210, the communicator 230, the camera module 240, and the display module 250. The processor 220 is configured to execute instructions stored in the memory 210 and to perform various processes for optimizing the camera (e.g., camera module 240) for the hand tracking in the HMD 200, as discussed throughout the disclosure. The processor 220 may include one or a plurality of processors, maybe a general-purpose processor, such as a Central Processing Unit (CPU), an Application Processor (AP), or the like, a graphics-only processing unit such as a Graphics Processing Unit (GPU), a Visual Processing Unit (VPU), and/or an Artificial Intelligence (AI) dedicated processor such as a Neural Processing Unit (NPU).

In one or more embodiments, the processor 220 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the processor 220 may include a context detection module 221, a hand gesture prediction module 222, a hand trajectory prediction module 223, a hand-speed analyzing module 224, and an image processing module 225.

In one or more embodiments, the context detection module 221 detects an initiation of a hand gesture present in a plurality of image frames, which are generated by the camera module 240 of the HMD 200. The context detection module 221 further extracts one or more characteristics that provide insights into a context associated with the plurality of generated image frames. The one or more characteristics comprise at least one of objects, people, activities, or environmental elements present in the plurality of generated image frames. The context detection module 221 further determines a correlation among the one or more extracted characteristics. The context detection module 221 further determines a context of the initiation of the hand gesture based on the determined correlation.

For instance, consider a scenario where trainees practice procedures in a simulated environment in a surgical training program. The camera module 240 detects the hand gesture initiated by a trainee, such as reaching for a virtual scalpel. The context detection module 221 then analyzes the image frames to extract key characteristics, including the presence of surgical tools, a virtual patient, and other trainees in the room. By determining the correlation between the hand gesture and the action of starting a surgical incision, the context detection module 221 concludes that the hand gesture indicates the trainee is about to begin a surgical procedure.

For instance, in another scenario, the HMD 200 is used for AR navigation in a large shopping mall. The camera module 240 detects the hand gesture, like pointing towards a store. The context detection module 221 analyzes the image frames and identifies characteristics such as nearby stores, shoppers, and directional signs. The context detection module 221 finds the correlation between the pointing gesture and the identified store, along with the presence of people walking in that direction. Consequently, the context detection module 221 determines that the user is likely trying to navigate to that specific store.

In one or more embodiments, the hand gesture prediction module 222 predicts a type of hand gesture required based on the determined context of initiation. To predict the type of hand gesture, the hand gesture prediction module 222 may execute various operations, which are given below.

The hand gesture prediction module 222 determines one or more hand landmarks within each generated image frame using a hand landmark estimation model. The one or more hand landmarks may include, but are not limited to, a fingertip, a knuckle, and a palm region. The hand gesture prediction module 222 further analyzes a position of the one or more determined hand landmarks across the plurality of generated image frames. Each generated image frame is associated with a unique time stamp value. The hand gesture prediction module 222 further determines a movement of the one or more determined hand landmarks across the plurality of generated image frames based on the analyzed position. The hand gesture prediction module 222 further predicts the type of hand gesture based on the determined movement. The type of hand gesture may include, but is not limited to, a swipe gesture, a pointing gesture, a pinch gesture, a click gesture, a grab gesture, a palm raise gesture, a finger tapping gesture, and a hand rotation gesture.

For instance, consider a scenario associated with a Virtual Reality (VR) game. When a player moves their hands, the hand gesture prediction module 222 identifies key hand landmarks, such as fingertips and the palm. Each time the player makes a gesture, the hand gesture prediction module 222 captures images of their hands, each marked with a specific time. For another instance, when the player swipes their hand to the right, the hand gesture prediction module 222 tracks the movement of the fingertips across several frames. The hand gesture prediction module 222 detects a quick lateral motion and recognizes that the player is likely performing the swipe gesture. Similarly, if the player brings their fingers together towards the palm, the hand gesture prediction module 222 detects this as the pinch gesture. By accurately predicting these gestures, the game allows the player to navigate menus or pick up virtual objects simply by moving their hands.

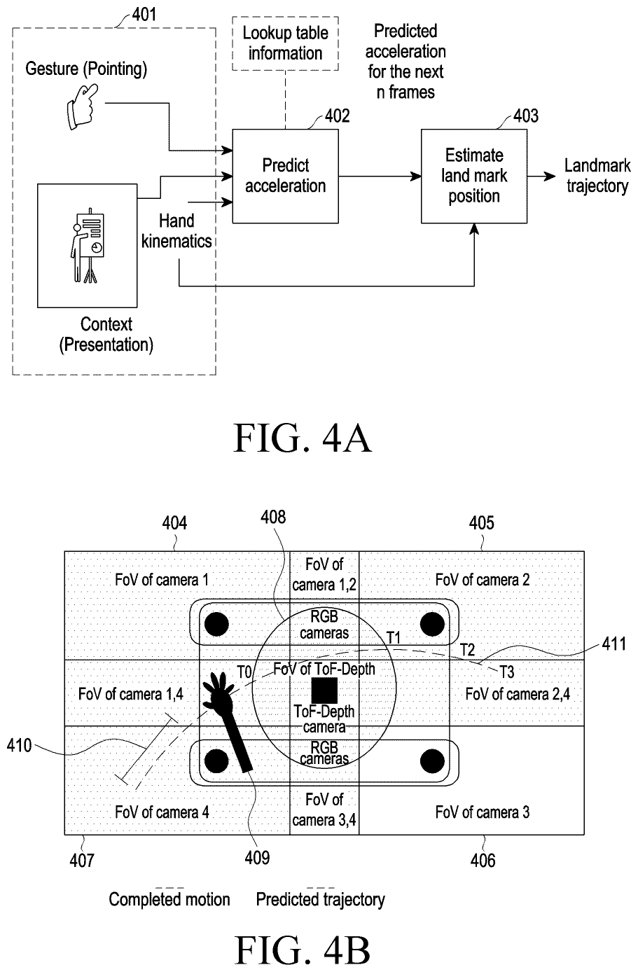

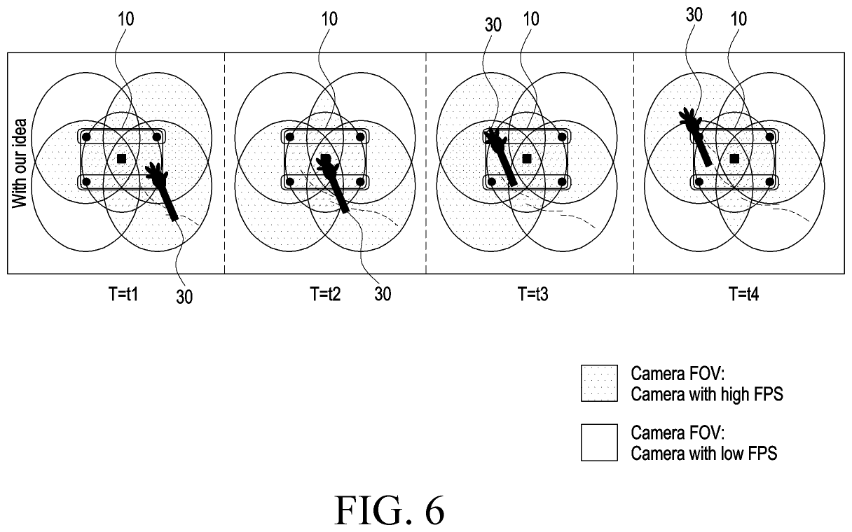

In one or more embodiments, the hand trajectory prediction module 223 predicts a trajectory of hand motion required to perform the hand gesture, as illustrated and described in conjunction with FIGS. 4A, 4B, and 6. To predict the trajectory of hand motion, the hand trajectory prediction module 223 may execute various operations, which are given below.

The hand trajectory prediction module 223 detects one or more hand landmark positions associated with the initiated hand gesture by utilizing the hand gesture prediction module 222. The hand trajectory prediction module 223 further estimates a speed of the one or more detected hand landmark positions over a time. The hand trajectory prediction module 223 further utilizes a predictive model to forecast one or more future hand landmark positions based on the determined context of initiation and the estimated speed. The hand trajectory prediction module 223 further predicts the trajectory of hand motion based on the one or more forecasted future hand landmark positions.

For instance, in a VR gaming setting, players use hand gestures to interact with the game. The hand trajectory prediction module 223 plays a crucial role in improving this interaction by accurately predicting one or more movements associated with the players. When the players raise their hand to perform a gesture, like a “swipe” to cast a spell, the hand trajectory prediction module 223 detects this action and identifies key hand positions, such as the fingertips and palm center. As the player swipes their hand, the hand trajectory prediction module 223 calculates the speed of these hand positions over time, measuring how quickly the fingertips move across the screen. The hand trajectory prediction module 223 also considers the context of the gesture, including the player's previous actions and the current game environment. This information helps refine the prediction process. Using the estimated speed and context, the hand trajectory prediction module 223 forecasts where the hand will be in the next few moments, anticipating that it will continue moving in a specific direction. Finally, based on these future hand positions, the hand trajectory prediction module 223 predicts the trajectory of the hand's motion.

The hand trajectory prediction module 223 further determines one or more current acceleration values from the plurality of generated image frames. The hand trajectory prediction module 223 further determines a final acceleration value using the determined context of initiation and the one or more hand gestures from a pre-defined look-up table. The pre-defined look-up table may include, but is not limited to, the contextual information, the hand gesture, a final acceleration value for each combination of the contextual information and the hand gesture, and a decay time value for each combination of the contextual information and the hand gesture, for example, as shown in Table 1.

TABLE 1

| Context | Gesture | Final acceleration | Decay time |
|---|---|---|---|
| Presentation | Pointing | −5 | 30 ms |
| Moving Virtual Objects | Swipe | 0 | 15 ms |

In one embodiment, the pre-defined look-up table is created using historical data. The hand trajectory prediction module 223 further determines the decay time value/period using the determined context of initiation and the one or more hand gestures from the pre-defined look-up table. The decay time period denotes a time required for acceleration to reduce from the one or more determined current acceleration values to the determined final acceleration value. The hand trajectory prediction module 223 further decreases the one or more determined current acceleration values linearly over the decay time period until the determined final acceleration value is reached (e.g., predicted acceleration after decay time=final acceleration), to determine future hand trajectory data.

For instance, consider an example scenario where users control a drone using hand gestures. When a user raises their hand to signal the drone to ascend, the hand trajectory prediction module 223 analyzes multiple generated image frames to determine the current acceleration values of the hand movement. This involves assessing how quickly the hand is moving at that moment. The hand trajectory prediction module 223 references the pre-defined look-up table that contains various hand gestures, contextual information (such as the user's previous commands), and corresponding final acceleration values for each gesture. This pre-defined look-up table may be created using historical data from previous interactions, allowing the hand trajectory prediction module 223 to learn and adapt over time. Using the context of the initiated gesture and the identified hand movement, the hand trajectory prediction module 223 determines the final acceleration value. For instance, if the user's hand is moving upward to indicate ascent, the module might identify a final acceleration value that reflects a steady climb for the drone.

In one or more embodiments, the hand-speed analyzing module 224 identifies at least one camera among the plurality of cameras of the HMD whose Field Of View (FOV) intersects with the estimated hand speed at the plurality of points along with the predicted trajectory, as illustrated and described in conjunction with FIGS. 4B and 6. In other words, identifying, by the HMD, at least one camera, among the plurality of cameras of the HMD, corresponding to the plurality of points based on FOV of the plurality of cameras is configured to identify at least one camera, among the plurality of cameras of the HMD, corresponding to the plurality of points based on FOV of the plurality of cameras.

In one embodiment, the hand-speed analyzing module 224 determines a velocity of each hand landmark associated with the plurality of generated image frames and an acceleration of each hand landmark associated with the plurality of generated image frames. The hand-speed analyzing module 224 estimates the hand speed based on the determined velocity and determined acceleration.

In one embodiment, the hand-speed analyzing module 224 determines a 3-dimensional acceleration based on the pre-defined look-up table and the estimated hand speed.

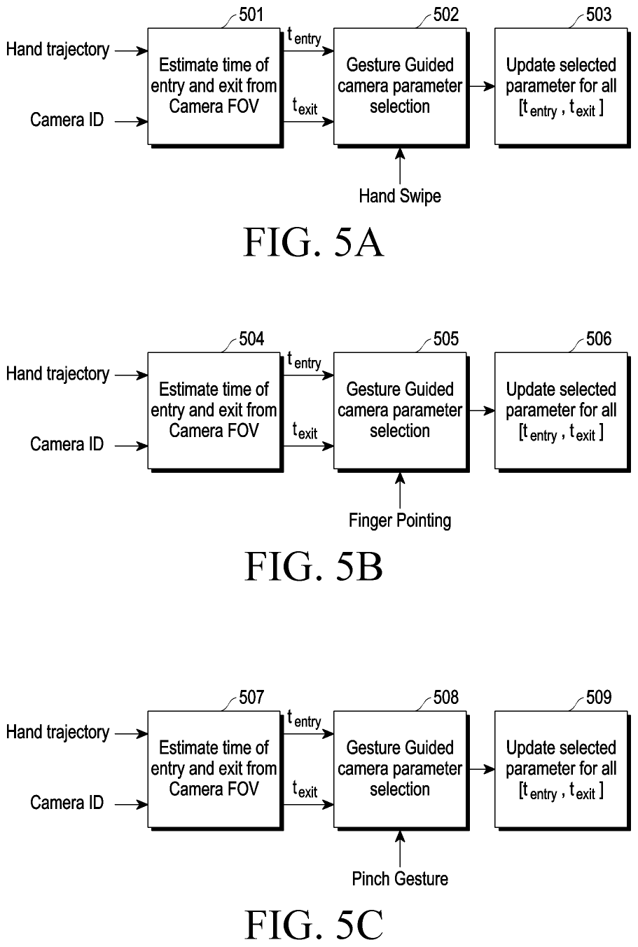

In one embodiment, the hand-speed analyzing module 224 determines one or more locations of one or more FOVs from a calibration file. The hand-speed analyzing module 224 further determines an entry time value and an exist time value from the one or more FOVs, as illustrated and described in conjunction with FIGS. 5A, 5B, and 5C. The entry time value indicates a time when the determined location enters an FOV of the at least one camera (e.g., camera module 240). The exist time value indicates a time when the determined location exists in the FOV of the at least one camera.

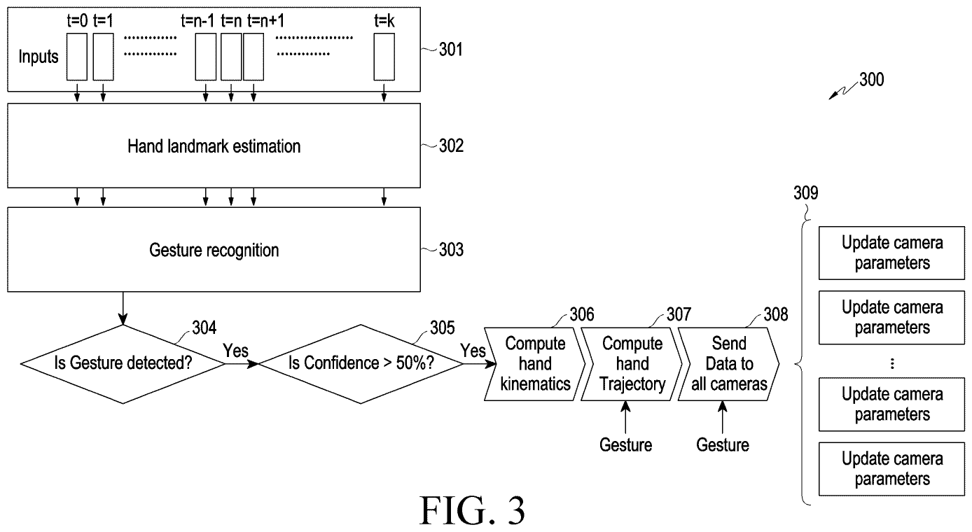

In one or more embodiments, the image processing module 225 configures one or more operation parameters of the at least one camera in proportion to the estimated hand speed. In other words, the image processing module 225 determines whether one or more hand gestures fall within one or more FOVs of the HMD, as illustrated and described in conjunction with FIGS. 3 and 6. The image processing module 225 configures the at least one camera to operate at a high Frame Per Second (FPS) and a high-resolution mode in response to determining that the one or more hand gestures fall within the one or more FOVs. The image processing module 225 configures the at least one camera to operate at low FPS and a low-resolution mode in response to determining that the one or more hand gestures do not fall within the one or more FOVs.

In one or more embodiments, the communicator 230 is configured for communicating internally between internal hardware components and with external devices (e.g., server) via one or more networks (e.g., radio technology). The communicator 230 includes an electronic circuit specific to a standard that enables wired or wireless communication.

In one or more embodiments, the camera module 240 includes one or more image sensors (e.g., Charged Coupled Device (CCD), Complementary Metal-Oxide Semiconductor (CMOS)) to capture one or more images/image frames/video to be processed for optimizing the camera for the hand tracking.

In one or more embodiments, the display module 250 can accept user inputs and is made of a Liquid Crystal Display (LCD), a Light Emitting Diode (LED), an Organic Light Emitting Diode (OLED), or another type of display. The user inputs may include but are not limited to, touch, swipe, drag, gesture, and so on.

In one or more embodiments, a function associated with the various components of the HMD 200 may be performed through the non-volatile memory, the volatile memory, and the processor 220. One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning algorithm to a plurality of learning data, a predefined operating rule or AI model of the desired characteristic is made. The learning may be performed in a device itself in which AI according to an embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks may include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

Although FIG. 2 shows various hardware components of the HMD 200, but it is to be understood that other embodiments are not limited thereon. In other embodiments, the HMD 200 may include less or more number of components. Further, the labels or names of the components are used only for illustrative purposes and do not limit the scope of the disclosure. One or more components can be combined to perform the same or substantially similar functions to optimize the camera.

FIG. 3 is a flow diagram illustrating a method 300 for dynamically configuring the one or more operation parameters of the at least one camera (e.g., camera module 240) associated with the HMD 200, according to an embodiment of the disclosure. The method 300 may execute multiple operations to dynamically configure the one or more operation parameters, which are given below.

At operation 301, the method 300 includes capturing a sequential series of image frames (e.g., at time intervals t=0, t=1, . . . , t=k) utilizing one or more image sensors (e.g., camera module 240) to generate a continuous stream of visual data that encompasses one or more hand gestures. At operation 302, the method 300 further includes incorporating an application of a hand landmark estimation model, such as MediaPipe Hands, which is employed to detect and localize significant key points on the hand, including fingertips, knuckles, and palm landmarks, within each captured image frame.

Subsequently, at operation 303, the method 300 includes utilizing a gesture recognition algorithm to analyze a spatial configuration and movement of the detected hand landmarks across multiple frames, facilitating the identification of specific gestures or hand poses. This analysis may utilize advanced techniques such as dynamic time warping, machine learning classifiers, or deep neural networks. The recognized gestures are then classified according to predefined gesture categories (e.g., thumbs up, peace sign, fist).

Additionally, at operations 304-305, the method 300 includes an evaluation process to ascertain whether the identified gestures or hand poses have been accurately classified, or to determine if the confidence score associated with the identification or classification of the specific gestures or hand poses exceeds a predefined threshold value (e.g., 50%).

At operation 306, if the classification meets above-mentioned criterion, the method 300 includes proceeding to analyze hand kinematics. The hand kinematics refers to the quantification of the hand's velocity and acceleration, derived from the hand landmarks observed in the last n image frames. At operation 307, the method 300 also encompasses the determination of the hand trajectory, which integrates both gesture recognition and hand kinematics to estimate the trajectory of the hand. Specifically, the hand kinematics provides real-time data regarding velocity and acceleration, while gesture recognition offers insights into the temporal variations of the acceleration. These combined datasets are utilized to compute the hand trajectory, culminating in the estimation of hand speed at various points along the predicted trajectory.

Moreover, at operations 308-309, upon determining the hand trajectory, the method 300 includes identifying the at least one camera among the plurality of cameras of the HMD 200 whose FOV intersects with the estimated hand speed at the plurality of points along with the predicted trajectory. The method 300 further includes configuring the one or more operation parameters of the at least one camera in proportion to the estimated hand speed.

FIGS. 4A and 4B illustrate example scenarios where the HMD 200 performs to determine future hand trajectory data corresponding to one or more FOVs of the HMD 200, according to various embodiments of the disclosure.

Referring to FIG. 4A, at operations 401-402, the disclosed method involves a comprehensive analysis of gesture recognition, contextual interpretation, and hand kinematics through a series of sequential image frames. The disclosed method encompasses the prediction of specific gestures (e.g., pointing), contextual scenarios (e.g., during a presentation), and the associated hand kinematics. For instance, consider a scenario where a presenter is using hand gestures to emphasize points during a presentation. The disclosed method first predicts the type of gesture being performed such as a swipe or a point by analyzing the visual data from multiple image frames. Based on the identified gesture and the contextual setting, the disclosed method computes the expected future acceleration of the hand.

For instance, in the case of the swipe gesture, the anticipated acceleration would be minimal, approximating zero, indicating a smooth and continuous motion. Conversely, if the gesture is identified as a pointing action within a presentation context, it may likely result in a sudden negative acceleration, reflecting a rapid deceleration as the presenter pauses to emphasize a specific point. The calculation of future acceleration leverages the pre-defined look-up table, which provides quick access to expected acceleration values based on predefined gesture-context combinations. This approach enhances the efficiency of the prediction process. Moreover, the method employs a standard kinematic equation, as mentioned below.

$$S = u * t + 0.5 at \hat{} 2 \qquad Equation 1$$

Where ‘S’ represents displacement, ‘u’ represents an initial velocity, ‘a’ represents an acceleration, and ‘t’ represents the time. This equation facilitates the estimation of landmark positions over the next ‘n’ frames, utilizing the predicted acceleration derived from the identified gesture. At operation 403, furthermore, the disclosed method incorporates the estimation of the trajectory of hand motion, referred to as the landmark trajectory. This landmark trajectory is derived from the estimated landmark positions, providing a detailed representation of the hand's movement throughout the gesture. By integrating gesture prediction, contextual analysis, and kinematic modeling, the disclosed method offers an advanced framework for understanding and interpreting dynamic hand movements in real-time scenarios.

Referring to FIG. 4B, it illustrates an example scenario where a multi-camera setup is used to track hand gestures and predict trajectories. Here, each section (e.g., 404, 405, 406, and 407) represents the FOV of different cameras, which work together to capture the movement of a user's hand 409. In this multi-camera setup, these cameras are positioned strategically to cover overlapping areas (e.g., FOV of camera 1,2), ensuring comprehensive coverage of the user's hand movements. In addition, a circular area 408 labeled “FOV of ToF depth camera” indicates the coverage of a depth-sensing camera. This depth-sensing camera captures not only the position of the hand 409 but also its distance from the camera, providing additional context for gesture recognition. The depth-sensing camera allows the disclosed method to better understand the hand's position 409 in 3D space.

Here, a dashed left-side line 410 represents a completed motion of the hand 409. This dashed left-side line 410 shows where the hand has moved, providing a reference for the disclosed method to compare against the predicted trajectory. The completed motion can be used to refine future predictions, enhancing the accuracy of the gesture recognition system. Moreover, a dashed right-side line 411 indicates a predicted trajectory of the hand's motion 409. In this example scenario, the predicted trajectory is associated with one or more timestamps (e.g., T0, T1, T2, T3). The trajectory is divided into segments, labeled T0, T1, T2, and T3, representing various points in the motion. These points help the disclosed method to anticipate the future positions of the hand. This trajectory is determined using the hand trajectory prediction module 223, which considers the current acceleration values, contextual information, and historical data from the pre-defined look-up table. In one embodiment, by referencing the pre-defined look-up table, the hand trajectory prediction module 223 continuously updates the predicted trajectory as the user performs gestures, allowing for real-time adjustments and responses.

FIGS. 5A, 5B, and 5C illustrate example scenarios where the HMD 200 performs one or more operations to dynamically configure the at least one camera, according to various embodiments of the disclosure.

Referring to FIG. 5A, at operation 501, the disclosed method includes estimating the time of entry and exit of the hand from the camera's FOV by utilizing predicted hand trajectories in conjunction with camera identification linked to the HMD 200. At operations 502-503, upon ascertaining the precise moments of entry and exit, a gesture-guided camera parameter selection module, which may relate to the image processing module 225, dynamically configures one or more operational parameters of the relevant camera(s) to optimize performance for specific gestures. In this example scenario, one of the gestures identified is the “hand swipe”. Given the high likelihood of motion blur during this gesture, it is crucial to capture images in a manner that minimizes blur. Consequently, an increase in the FPS, by the image processing module 225, is necessitated. The FPS of the cameras, which are positioned within the predicted path of the hand between the timestamps t entry and t exit, is therefore elevated to ensure clarity and precision in the captured footage.

Referring to FIG. 5B, at operation 504, the disclosed method includes estimating the time of entry and exit of the hand from the camera's FOV by utilizing predicted hand trajectories in conjunction with camera identification linked to the HMD 200. At operations 505-506, upon ascertaining the precise moments of entry and exit, the gesture-guided camera parameter selection module, which may relate to the image processing module 225, dynamically configures one or more operational parameters of the relevant camera(s) to optimize performance for specific gestures. In this example scenario, the gesture recognized is the “finger pointing”. In this case, the hand initially moves before stabilizing to point at a specific object. During the static phase of this gesture, it is imperative that the accuracy of hand landmark detection is maximized to accurately determine the direction of the point. To achieve this, a high-resolution (HR) video stream from the corresponding camera is activated, by the image processing module 225, during the duration of the static gesture.

Referring to FIG. 5C, at operation 507, the disclosed method includes estimating the time of entry and exit of the hand from the camera's FOV by utilizing predicted hand trajectories in conjunction with camera identification linked to the HMD 200. At operations 508-509, upon ascertaining the precise moments of entry and exit, the gesture-guided camera parameter selection module, which may relate to the image processing module 225, dynamically configures one or more operational parameters of the relevant camera(s) to optimize performance for specific gestures. In this example scenario, the gesture recognized is the “pinch gesture”. For the pinch gesture, there is a critical requirement for high accuracy in depth perception. Since this pinch gesture is executed rapidly, the FPS of the associated camera is increased, by the image processing module 225, to capture the motion effectively. Furthermore, the ToF sensor is configured to operate in either long-range or short-range mode, contingent upon the anticipated trajectory of the camera, thereby enhancing the overall depth accuracy during the gesture recognition process.

FIG. 6 illustrates an example scenario where the HMD 200 performs one or more operations to dynamically configure the at least one camera to operate at a various FPS and/or a various resolution mode, according to an embodiment of the disclosure.

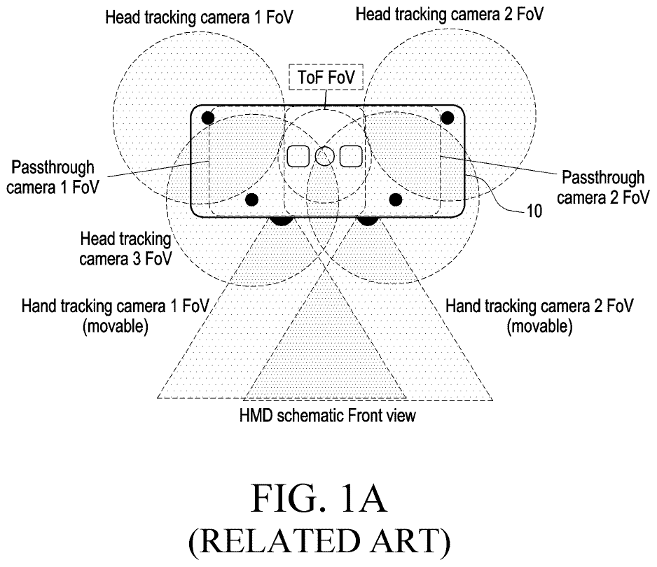

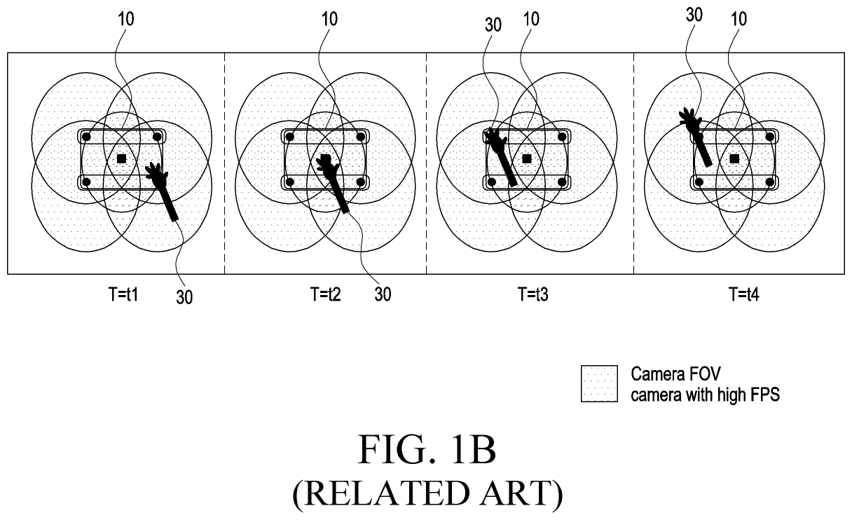

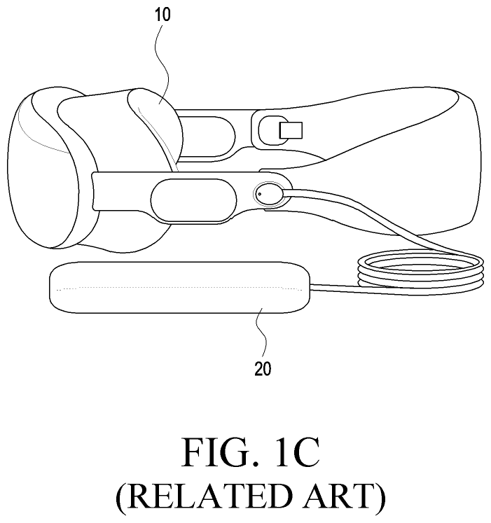

As previously mentioned, the existing system lacks the capability to discern when high frame rates are unnecessary, particularly when the user's hand is absent from the camera's FOV, as illustrated in FIG. 1B. In contrast, the disclosed method enables the processor 220 to adjust operational parameters for the plurality of cameras based on various factors, including the type of hand gesture, the trajectory of hand motion, the hand speed, and intersection data related to the FOV (e.g., tentry, texist). The one or more cameras that are relevant to the user's actions can be operated in high-performance mode or high-resolution mode, as depicted in the figure's “dark circle”. For instance, the disclosed method is designed to increase resolution selectively when the hand is poised to execute a gesture, e.g., the pinch gesture. Conversely, the one or more cameras that do not capture the hand within the center or FOV operate at the low FPS and the low-resolution mode, as indicated in the figure's “light circle”. This adaptive strategy optimizes resource allocation and processing efficiency while maintaining responsiveness to user interactions.

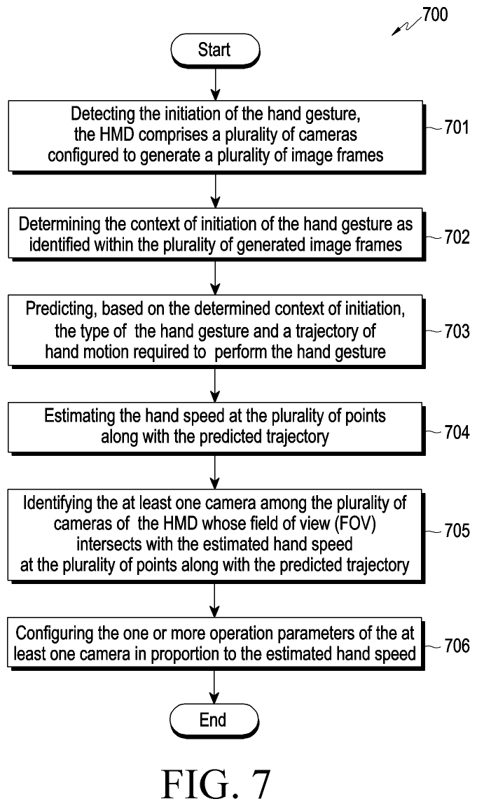

FIG. 7 is a flow diagram illustrating a method 700 for dynamically configuring the one or more operation parameters of the at least one camera (e.g., 240) associated with the HMD 200, according to an embodiment of the disclosure. The method 700 may execute multiple operations to dynamically configure the one or more operation parameters, which are given below.

At operation 701, the method 700 includes detecting the initiation of the hand gesture, where the HMD includes the plurality of cameras configured to generate the plurality of image frames. At operation 702, the method 700 includes determining the context of the initiation of the hand gesture as identified within the plurality of generated image frames. At operation 703, the method 700 includes predicting, based on the determined context of initiation, the type of hand gesture and the trajectory of hand motion required to perform the hand gesture. At operation 704, the method 700 includes estimating the hand speed at the plurality of points along with the predicted trajectory. At operation 705, the method 700 includes identifying the at least one camera among the plurality of cameras of the HMD whose FOV intersects with the estimated hand speed at the plurality of points along with the predicted trajectory. At operation 706, the method 700 includes configuring the one or more operation parameters of the at least one camera in proportion to the estimated hand speed. Further, a detailed description related to the various operations of FIG. 7 is covered in the description related to FIGS. 2, 3, 4A, 4B, 5A to 5C, and 6, and is omitted herein for the sake of brevity.

The disclosed method/system has several advantages over the existing mechanism/system, which are stated below.
a. Increased efficiency and performance: By dynamically adjusting camera parameters in response to contextual cues and predicted hand gestures, the disclosed method minimizes unnecessary resource utilization, ensuring that only pertinent cameras operate in high-performance modes as required. In addition, the disclosed method significantly decreases the volume of data processed and transmitted when hands are not within the FOV, by operating cameras at lower frame rates and resolutions, thereby improving overall system efficiency and performance.
b. Extended battery life: By optimizing camera operations based on user interactions, the disclosed method contributes to prolonging the battery life of the HMD 200, enhancing its practicality for prolonged usage. The disclosed method intelligently identifies which cameras necessitate operation at high/elevated frame rates and resolutions, conserving processing power and battery resources by reducing the workload on cameras that do not actively track hand movements.
c. Adaptive performance: Real-time adjustments based on hand speed and trajectory, ensuring that the disclosed method can accommodate varying user behaviors and environmental conditions, thereby enhancing tracking precision. By ascertaining the context of gesture initiation, the disclosed method gains a deeper understanding of user intent, leading to improved accuracy in gesture recognition and enhanced interaction quality.
d. Reduced latency: Configuring cameras based on anticipated hand movements can decrease latency in gesture recognition, facilitating smoother interactions in applications such as Virtual Reality (VR) and Augmented Reality (AR).
e. User-centric design: By prioritizing the specific requirements of hand tracking, the disclosed method enhances the overall user experience, making interactions more intuitive and engaging.

The various actions, acts, blocks, operations, or the like in the flow diagrams may be performed in the order presented, in a different order, or simultaneously. Further, in some embodiments, some of the actions, acts, blocks, operations, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for controlling a Head Mounted Device (HMD), the method comprising:
detecting, by the HMD, a gesture of a user, wherein the HMD comprises a plurality of cameras configured to obtain a plurality of image frames;
determining, by the HMD, a context of the gesture of the user as identified using the plurality of obtained image frames;
based on the context related to the gesture, predicting, by the HMD, a trajectory of the gesture;
estimating, by the HMD, a speed of a body part of the user corresponding to the gesture at a plurality of points included in the predicted trajectory;
identifying, by the HMD, at least one camera, among the plurality of cameras of the HMD, corresponding to the plurality of points based on FOV of the plurality of cameras; and
based on the estimated speed of the body part of the user, configuring, by the HMD, one or more operation parameters of the at least one camera corresponding to the plurality of points.

2. The method as claimed in claim 1, wherein configuring the one or more operation parameters comprises:
determining whether one or more gestures fall within one or more FOVs of the HMD; and
performing one of:
configuring the at least one camera to operate at a high Frame Per Second (FPS) and a high-resolution mode in response to determining that the one or more gestures fall within the one or more FOVs, or
configuring the at least one camera to operate at low FPS and a low-resolution mode in response to determining that the one or more gestures do not fall within the one or more FOVs.

3. The method as claimed in claim 1, wherein determining the context of initiation of the gesture comprises:
extracting one or more characteristics that provide insights into a context associated with the plurality of obtained image frames, wherein the one or more characteristics comprise at least one of objects, people, activities, or environmental elements present in the plurality of obtained image frames;
determining a correlation among the one or more extracted characteristics; and
determining, based on the determined correlation, the context of the initiation of the gesture.

4. The method as claimed in claim 1, further comprising predicting a type of the gesture, wherein predicting the type of gesture comprises:
determining, using a landmark estimation model for the body part, one or more landmarks of the body part within each obtained image frame, wherein the one or more hand landmarks comprise at least one of a fingertip, a knuckle, or a palm region;
analyzing a position of the one or more determined landmarks across the plurality of obtained image frames, wherein each obtained image frame is associated with a unique time stamp value;
determining, based on the analyzed position, a movement of the one or more determined landmarks across the plurality of obtained image frames; and
predicting, based on the determined movement, the type of gesture, wherein the type of gesture comprises at least one of a swipe gesture, a pointing gesture, a pinch gesture, a click gesture, a grab gesture, a palm raise gesture, a finger tapping gesture, or a hand rotation gesture.

5. The method as claimed in claim 1, wherein estimating the speed comprises:
determining a velocity of each landmark associated with the plurality of obtained image frames;
determining an acceleration of each landmark associated with the plurality of obtained image frames; and
estimating the speed based on the determined velocity and determined acceleration.

6. The method as claimed in claim 1, wherein predicting the trajectory of motion of the body part including a hand comprises:
detecting one or more hand landmark positions associated with the initiated hand gesture;
estimating a speed of the one or more detected hand landmark positions over a time;
utilizing a predictive model to forecast one or more future hand landmark positions based on the determined context of initiation and the estimated speed; and
predicting the trajectory of hand motion based on the one or more forecasted future hand landmark positions.

7. The method as claimed in claim 6, comprising:
determining one or more current acceleration values from the plurality of obtained image frames;
determining a final acceleration value using the determined context of initiation and the one or more gestures from a pre-defined look-up table;
determining a decay time period using the determined context of initiation and the one or more gestures from the pre-defined look-up table,
wherein the decay time period denotes a time required for acceleration to reduce from the one or more determined current acceleration values to the determined final acceleration value; and
decreasing the one or more determined current acceleration values linearly over the decay time period until the determined final acceleration value is reached, to determine future body part trajectory data.

8. The method as claimed in claim 7, comprising:
determining a 3-dimensional acceleration based on the pre-defined look-up table and the estimated speed,
wherein the pre-defined look-up table comprises contextual information, a gesture, a final acceleration value for each combination of the contextual information and the gesture, and a decay time value for each combination of the contextual information and the gesture, and
wherein the pre-defined look-up table is created using historical data.

9. The method as claimed in claim 1, comprising:
determining one or more locations of one or more FOVs from a calibration file; and
determining an entry time value and an exist time value from the one or more FOVs,
wherein the entry time value indicates a time when the determined location enters a FOV of the at least one camera, and
wherein the exist time value indicates a time when the determined location exists in the FOV of the at least one camera.

10. A Head Mounted Device (HMD), the HMD comprising:
memory storing one or more computer programs; and
one or more processors, communicatively coupled to the memory, a communicator, a camera module and a display module,
wherein the one or more computer programs include computer-executable instructions that, when executed by the one or more processors individually or collectively, cause the HMD to:
detect a gesture of a user, wherein the HMD comprises a plurality of cameras configured to obtain a plurality of image frames,
determine a context of the gesture as identified using the plurality of obtained image frames,
based on the context related to the gesture, predict, a trajectory of hand motion required to perform the gesture,
estimate a speed of a body part of the user corresponding to the gesture at a plurality of points included in the predicted trajectory,
identify at least one camera, among the plurality of cameras of the HMD, corresponding to the plurality of points based on FOV of the plurality of cameras, and
based on the estimated speed of the body part of the user, configure one or more operation parameters of the at least one camera corresponding to the plurality of points.

11. The HMD as claimed in claim 10, wherein to configure the one or more operation parameters, the one or more computer programs further include computer-executable instructions that, when executed by the one or more processors individually or collectively, cause the HMD to:
determine whether one or more hand gestures fall within one or more FOVs of the HMD; and
perform one of:
configuring the at least one camera to operate at a high Frame Per Second (FPS) and a high-resolution mode in response to determining that the one or more hand gestures fall within the one or more FOVs, or
configuring the at least one camera to operate at low FPS and a low-resolution mode in response to determining that the one or more hand gestures do not fall within the one or more FOVs.

12. The HMD as claimed in claim 10, wherein to determine the context of initiation of the hand gesture, the one or more computer programs further include computer-executable instructions that, when executed by the one or more processors individually or collectively, cause the HMD to:
extract one or more characteristics that provide insights into a context associated with the plurality of obtained image frames, wherein one or more characteristics comprise at least one of objects, people, activities, or environmental elements present in the plurality of obtained image frames;
determine a correlation among the one or more extracted characteristics; and
determine, based on the determined correlation, the context of the initiation of the hand gesture.

13. The HMD as claimed in claim 10, wherein to predict the type of hand gesture, the one or more computer programs further include computer-executable instructions that, when executed by the one or more processors individually or collectively, cause the HMD to:
determine, using a hand landmark estimation model, one or more hand landmarks within each obtained image frame, wherein the one or more hand landmarks comprise at least one of a fingertip, a knuckle, or a palm region;
analyze a position of the one or more determined hand landmarks across the plurality of obtained image frames, wherein each obtained image frame is associated with a unique time stamp value;
determine, based on the analyzed position, a movement of the one or more determined hand landmarks across the plurality of obtained image frames; and
predict, based on the determined movement, the type of hand gesture, wherein the type of hand gesture comprises at least one of a swipe gesture, a pointing gesture, a pinch gesture, a click gesture, a grab gesture, a palm raise gesture, a finger tapping gesture, or a hand rotation gesture.

14. The HMD as claimed in claim 10, wherein to estimate the speed, the one or more computer programs further include computer-executable instructions that, when executed by the one or more processors individually or collectively, cause the HMD to:
determine a velocity of each hand landmark associated with the plurality of obtained image frames;
determine an acceleration of each hand landmark associated with the plurality of obtained image frames; and
estimate the speed based on the determined velocity and determined acceleration.

15. The HMD as claimed in claim 10, wherein to predict the trajectory of hand motion, the one or more computer programs further include computer-executable instructions that, when executed by the one or more processors individually or collectively, cause the HMD to:
detect one or more hand landmark positions associated with the initiated hand gesture;
estimate a speed of the one or more detected hand landmark positions over a time;
utilize a predictive model to forecast one or more future hand landmark positions based on the determined context of initiation and the estimated speed; and
predict the trajectory of hand motion based on the one or more forecasted future hand landmark positions.

16. The HMD as claimed in claim 15, wherein the one or more computer programs further include computer-executable instructions that, when executed by the one or more processors individually or collectively, cause the HMD to:
determine one or more current acceleration values from the plurality of obtained image frames;
determine a final acceleration value using the determined context of initiation and the one or more hand gestures from a pre-defined look-up table;
determine a decay time period using the determined context of initiation and the one or more hand gestures from the pre-defined look-up table, wherein the decay time period denotes a time required for acceleration to reduce from the one or more determined current acceleration values to the determined final acceleration value; and
decrease the one or more determined current acceleration values linearly over the decay time period until the determined final acceleration value is reached, to determine future hand trajectory data.

17. The HMD as claimed in claim 16, the one or more computer programs further include computer-executable instructions that, when executed by the one or more processors individually or collectively, cause the HMD to:
determine a 3-dimensional acceleration based on the pre-defined look-up table and the estimated speed,
wherein the pre-defined look-up table comprises the contextual information, a hand gesture, a final acceleration value for each combination of the contextual information and the hand gesture, and a decay time value for each combination of the contextual information and the hand gesture, and
wherein the pre-defined look-up table is created using historical data.

18. The HMD as claimed in claim 10, the one or more computer programs further include computer-executable instructions that, when executed by the one or more processors individually or collectively, cause the HMD to:
determine one or more locations of one or more FOVs from a calibration file; and
determine an entry time value and an exist time value from the one or more FOVs,
wherein the entry time value indicates a time when the determined location enters a FOV of the at least one camera, and
wherein the exist time value indicates a time when the determined location exists in the FOV of the at least one camera.

19. The HMD as claimed in claim 10, wherein configuring the one or more operation parameters of the at least one camera based on the estimated speed is configured to conserve battery power and/or reduce latency in gesture recognition.

20. One or more non-transitory computer-readable storage media storing one or more computer programs including computer-executable instructions that, when executed by one or more processors of a Head Mounted Device (HMD) individually or collectively, cause the HMD to perform operations, the operations comprising:
detecting, by the HMD, a gesture of a user, wherein the HMD comprises a plurality of cameras configured to obtain a plurality of image frames;
determining, by the HMD, a context of the gesture of the user as identified using the plurality of obtained image frames;
based on the context related to the gesture, predicting, by the HMD, a trajectory of the gesture;
estimating, by the HMD, a speed of a body part of the user corresponding to the gesture at a plurality of points included in the predicted trajectory;
identifying, by the HMD, at least one camera, among the plurality of cameras of the HMD, corresponding to the plurality of points based on FOV of the plurality of cameras; and
based on the estimated speed of the body part of the user, configuring, by the HMD, one or more operation parameters of the at least one camera corresponding to the plurality of points.
